(19) United States
(12) Patent Application Publication
(10) Pub. No.: US 2018/0115749 A1
(43) Pub. Date: Apr. 26, 2018

(54) SURVEILLANCE SYSTEM AND SURVEILLANCE METHOD

(71) Applicant: NEC CORPORATION, Tokyo (JP)

(72) Inventors: Hirokazu TOSHIYUKI, Tokyo (JP); Sho RYO, Tokyo (JP); Hideki NAKATA, Tokyo (JP); Eishi ARITA, Tokyo (JP); Shogo SHIGERU, Tokyo (JP)

(73) Assignee: NEC CORPORATION, Tokyo (JP)

(21) Appl. No.: 15/559,462

(22) PCT Filed: Feb. 12, 2016
(86) PCT No.: PCT/JP2016/054158

§ 371 Date: Sep. 19, 2017

(30) Foreign Application Priority Data
Mar. 19, 2015 (JP) 2015-056875

(51) Int. Cl. H04N 7/18; G06K 9/00; H04N 5/92

(52) U.S. Cl. CPC H04N 7/181; G06K 9/00335; H04N 5/445; H04N 5/9201; G06K 2209/27; G06K 9/00771

(57) ABSTRACT

Provided is a video surveillance technique of preventing erroneous detection.

The surveillance system has a sensing unit that detects a predetermined motion of a person appearing in a video, a storage processing unit that causes a storage unit to store information indicating the person whose motion is detected as a predetermined motion in association with the detected number of times, and a setting unit that sets the person as a suspect on the basis of the detected number of times

### TECHNICAL FIELD

The present invention relates to a video surveillance technique.

### BACKGROUND ART

Various methods have been proposed for monitoring videos and detecting certain types of behavior. For example, Patent Document 1 proposes a suspicious behavior detection system that detects a suspicious behavior of a surveillance target by using a video of a stereo camera. This system acquires movement trajectory information of the surveillance target, identifies a behavior state of the surveillance target on the basis of the movement trajectory information, and automatically determines the suspicious behavior of the surveillance target.

### RELATED DOCUMENT

### Patent Document

[Patent Document 1] Japanese Unexamined Patent Application Publication No. 2012-128877

### SUMMARY OF THE INVENTION

### Technical Problem

However, complete elimination of erroneous determination in the automatic determination of the suspicious behavior using a video as in the above proposed method is difficult to achieve, since, although it is possible to detect a behavior which is predetermined as suspicious, an ordinary person who is not a suspicious individual may accidentally take the predetermined behavior. Behaviors such as intrusion into a restricted area, falling down, and running can be mechanically determined as behaviors to be detected, thus reducing erroneous determination. However, suspicious behaviors and motions of theft such as shoplifting and pickpocketing cannot be uniformly determined on the basis of certain motions. Therefore, when determining such specific behaviors, there are no motions directly linked to such specific behaviors. Thus, motions which possibly may correspond to such specific behaviors are set as motions to be detected. As a result, a possibility of an ordinary person accidentally taking the behaviors set as the motions to be detected increases, and erroneous determination based on the detection of the motion of the ordinary person increases. Operation of notifying a clerk or a security guard at every determination of the above specific behavior including an erroneous determination is not practical.

The present invention has been made in consideration of such situations, and provides a video surveillance technique of preventing erroneous determination.

### Solution to Problem

In aspects of the present invention, in order to solve the above-mentioned problem, the following configurations are respectively adopted.

A first aspect relates to a surveillance system. A surveillance system according to the first aspect includes: a sensing unit that detects a predetermined motion of a person appearing in a video; a storage processing unit that causes a storage unit to store information indicating the person whose motion is detected as a predetermined motion, in association with the detected number of times; and a setting unit that sets the person as a suspect on the basis of the detected number of times.

A second aspect relates to a surveillance method executed by at least one computer. A surveillance method according to the second aspect includes: detecting a predetermined motion of a person appearing in a video; storing in a storage unit information indicating the person whose motion is detected as a predetermined motion, in association with the detected number of times; and setting the person as a suspect on the basis of the detected number of times.

In addition, according to another aspect of the present invention, there is a program for causing at least one computer to execute the method according to the second aspect. Further, another aspect relates to a storage medium recording such a program and readable by a computer. The storage medium includes a non-transitory type medium.

### Advantageous Effects of Invention

According to the aspects, it is possible to provide a video surveillance technique of preventing erroneous determination.

### BRIEF DESCRIPTION OF THE DRAWINGS

The above-mentioned objects and other objects, features and advantages will become more apparent with reference to the preferred example embodiments to be described later and the accompanying drawings.

FIG. 1 is a diagram conceptually illustrating a hardware configuration example of a surveillance system according to a first example embodiment.

FIG. 2 is a diagram conceptually illustrating a processing configuration example of a surveillance control apparatus according to the first example embodiment.

FIG. 3 is a diagram illustrating an example of a detection information storage unit according to the first example embodiment.

FIG. 4 is a diagram illustrating a first example of a display.

FIG. 5 is a diagram illustrating a second example of a display.

FIG. 6 is a flowchart illustrating an operation example of the surveillance control apparatus according to the first example embodiment.

FIG. 7 is a flowchart illustrating an operation example of the surveillance control apparatus according to the first example embodiment.

FIG. 8 is a flowchart illustrating an operation example of the surveillance control apparatus according to the first example embodiment.

FIG. 9 is a diagram illustrating an example of a detection information storage unit according to a second example embodiment.

FIG. 10 is a diagram conceptually illustrating a processing configuration example of a surveillance system according to a third example embodiment.

FIG. 11 is a flowchart illustrating an operation example of a surveillance system according to the third example embodiment.

### DESCRIPTION OF EMBODIMENTS

Hereinafter, example embodiments of the present invention will be described. In addition, the example embodiments to be described later are respectively just examples, and the present invention is not limited to the configurations of the following example embodiments.

### First Example Embodiment

### [System Configuration]

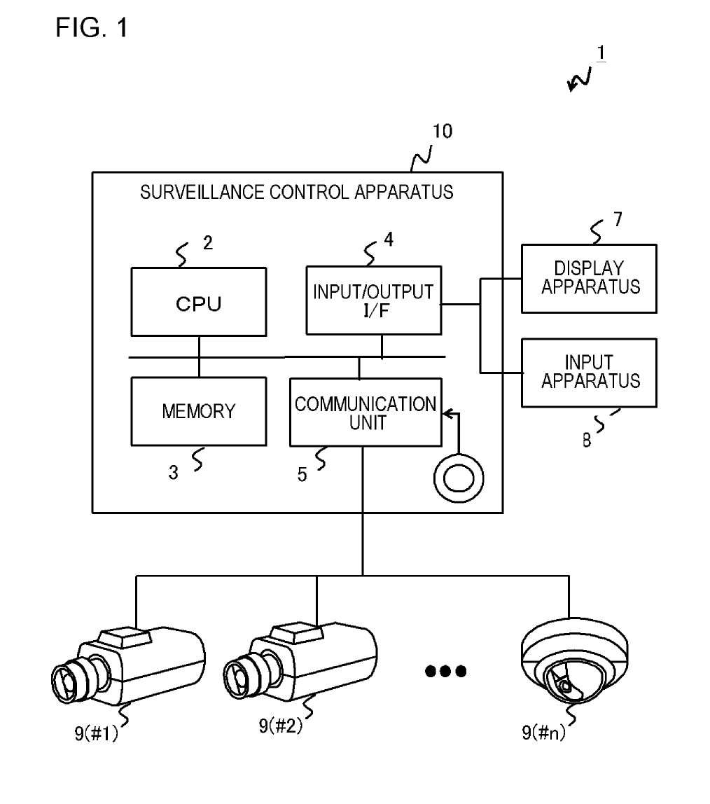

FIG. 1 is a diagram conceptually illustrating a hardware configuration example of a surveillance system 1 according to a first example embodiment. The surveillance system 1 has a surveillance control apparatus 10, a plurality of surveillance cameras 9(#1), 9(#2), and 9(#n), and the like.

The surveillance system 1 determines a suspect among persons whose motions are detected as predetermined motions on the basis of images captured by the surveillance cameras 9. The “suspect” is defined to include not only a suspect of a crime, but also persons who are difficult to uniformly determine as suspects on the basis of certain motion who continuously exhibit specific behaviors. For example, the surveillance system 1 is able to determine, as a suspect, a crime suspect such as a shoplifter or a pickpocket, a suspect molester, a prowler who may be a criminal, a possibly lost child, or the like. However, the suspect is not limited to the examples described above. However, in order to facilitate understanding of description, the present example embodiment will be described using an example in which a suspect shoplifter is determined as a suspect.

The plurality of surveillance cameras 9(#1), 9(#2), and 9(#n) may be fixed type cameras with unchangeable image capturing directions, may be movable cameras with changeable image capturing directions, or may include both. Hereinafter, unless it is necessary to distinguish individual surveillance cameras, each surveillance camera is collectively referred to as a “surveillance camera 9”. Each surveillance camera 9 is installed in a different location, and captures an image of each imaging area. However, the surveillance cameras 9 may be installed such that an imaging area of one surveillance camera 9 overlaps that of at least one other surveillance camera 9.

The surveillance camera 9 sends a video signal (image frames) to a communication unit 5. The transmission rate of the image frames, which are sent by the surveillance camera 9 to the communication unit 5, is not limited. When the transmission rate of the image frames is high, the surveillance control apparatus 10 is able to acquire many image frames in a unit of time. Thus, it is possible to perform highly accurate surveillance control. The transmission rate of the image frames may be determined in accordance with the specification of the frame rate of the surveillance camera 9, the communication capacity between the surveillance control apparatus 10 and the surveillance camera 9, the accuracy required for the surveillance system 1, and the like. Further, as long as the surveillance camera 9 is able to output a video signal, performance and functions thereof are not limited.

The surveillance control apparatus 10 is a so-called computer, and has, for example, a central processing unit (CPU) 2, a memory 3, an input/output interface (I/F) 4, the communication unit 5, and the like which are connected through a bus. A hardware configuration shown in FIG. 1 is an example, and the hardware configuration of the surveillance control apparatus 10 is not limited to the example shown in FIG. 1. The surveillance control apparatus 10 may include other hardware elements not shown in the drawing. Further, the number of apparatuses and the number of hardware elements are not limited to the example of FIG. 1. For example, the surveillance system 1 may have a plurality of surveillance control apparatuses 10, and the surveillance control apparatus 10 may have a plurality of CPUs 2.

The CPU 2 may also include an application specific integrated circuit (ASIC), a digital signal processor (DSP), a graphics processing unit (GPU), and the like. The memory 3 includes a random access memory (RAM), a read only memory (ROM), and an auxiliary storage apparatus (such as a hard disk).

The input/output I/F 4 is connectable to a display apparatus 7, an input apparatus 8, and a user interface apparatus such as a printer (not shown in the drawing). The display apparatus 7 is an apparatus, such as a liquid crystal display (LCD) or a cathode ray tube (CRT) display, which outputs display corresponding to drawing data processed by the CPU 2. The display apparatus 7 may display each of images obtained from video signals sent from the surveillance cameras 9. The input apparatus 8 is an apparatus such as a keyboard or a mouse that accepts an input of a user operation. Further, a touch panel, in which the display apparatus 7 and the input apparatus 8 are integrated, may be connected to the input/output I/F4.

The communication unit 5 exchanges signals with other computers and devices through wired or wireless communication. In the present example embodiment, the communication unit 5 communicates with the plurality of surveillance cameras 9. The communication method between the communication unit 5 and each surveillance camera 9 is not limited. For example, the communication unit 5 acquires the video signals from the respective surveillance cameras 9, and sends instruction signals to the surveillance cameras 9. Further, a portable storage medium or the like can also be connected to the communication unit 5.

### [Processing Configuration]

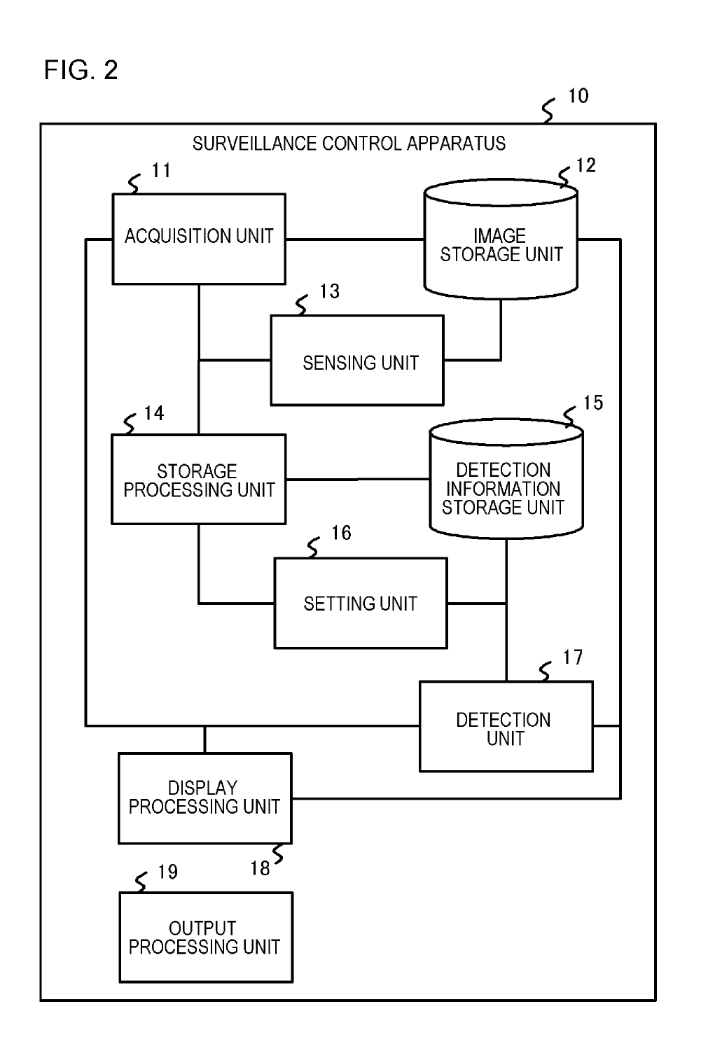

FIG. 2 is a diagram conceptually illustrating a processing configuration example of the surveillance control apparatus 10 according to the first example embodiment. As shown in FIG. 2, the surveillance control apparatus 10 has an acquisition unit 11, an image storage unit 12, a sensing unit 13, a storage processing unit 14, a detection information storage unit 15, a setting unit 16, a detection unit 17, a display processing unit 18, an output processing unit 19, and the like. The acquisition unit 11, the image storage unit 12, the sensing unit 13, the storage processing unit 14, the detection information storage unit 15, the setting unit 16, the detection unit 17, the display processing unit 18, and the output processing unit 19 are implemented, for example, by causing the CPU 2 to execute a program stored in the memory 3. Further, the program may be installed from a portable storage medium such as a compact disc (CD) or a memory card or from another computer on the network through the input/output I/F 4 or the communication unit 5, and may be stored in the memory 3.

The acquisition unit 11 acquires pieces of image data, which are captured by the respective surveillance cameras 9, from the respective surveillance cameras 9. Specifically, the acquisition unit 11 sequentially acquires the pieces of image data from the video signals which are sent from the surveillance cameras 9. At this time, the acquisition unit 11 may acquire the image data by capturing the input video signal at an arbitrary timing. The acquisition unit 11 stores the acquired pieces of image data in the image storage unit 12 in association with the pieces of identification information of the surveillance cameras 9 that has captured the images. The image data stored in the image storage unit 12 is either moving image data or still image data, or both.

The acquisition unit 11 may acquire image data from a portable storage medium, another computer, or the like through the communication unit 5. For example, the acquisition unit 11 may acquire image data from an image accumulation delivery apparatus that temporarily accumulates images captured by a camera and delivers the images, and may acquire image data from an image recorder that accumulates images and reproduces the images. Hereinafter, the image data acquired by the acquisition unit 11 and the image data stored in the image storage unit 12 may be referred to as images.

The sensing unit 13 detects each of multiple types of predetermined motions of a person appearing in a video from the images acquired by the acquisition unit 11 or the images stored in the image storage unit 12. Since the sensing unit performs such detection for each surveillance camera 9, the following explanation is made for an image group captured by one surveillance camera 9.

First, the sensing unit 13 detects a person from the image. The sensing unit 13 may detect the entire body of a person, or may detect a part of a person such as the head, the face, or the upper body. The sensing unit 13 detects a person using a well-known image recognition method. For example, the sensing unit 13 holds a feature value of an image corresponding to a detection range of a person, and detects an area similar to the feature value in the input image as the detection range. The method of detecting a person through the sensing unit 13 is not limited.

The sensing unit 13 detects multiple types of predetermined motions in the person detected as described above on the basis of images sequentially acquired from one surveillance camera 9. The multiple types of predetermined motions to be detected by the sensing unit 13 are set as motions continuously performed by a suspect and preferably distinguishable from motions of an ordinary person. In a case where a person can be determined as a candidate for a suspect by one type of the predetermined motion, the sensing unit 13 may detect only the one type of the predetermined motion. In a case where the suspect is a suspect shoplifter, the sensing unit 13 attempts to detect multiple types of predetermined motions such as a motion of taking out a product from a shopping basket, a motion of looking at a product held in the person's hand, a motion of looking around, and a motion of looking up toward the ceiling.

Depending on the type of the predetermined motion, the sensing unit 13 holds in advance image information of one or more human forms (shapes of appearance) allowing to identify the predetermined motions. For example, as for the motion of taking out a product from a shopping basket, image information of a human form of putting a hand in a shopping basket and image information of a human form of a person taking out the hand from the shopping basket are held. In addition, as for the motion of looking up toward the ceiling, image information of a human form of the face facing the ceiling is held. In this case, while tracking the detected person among a plurality of images, the sensing unit 13 finds the human form of the person as being a predetermined human form indicated by the held image information. As the method of tracking a person among a plurality of images, a well-known method of tracking an object and a person may be used. For example, the sensing unit 13 compares the feature values of the respective regions of persons detected in each image, and recognizes the approximated regions of persons as the same person. The method of tracking a person through the sensing unit 13 is not limited. However, it is possible to detect a person's predetermined form without performing tracking among a plurality of images. In this case, for example, the sensing unit 13 detects a person in each image, and detects that the detected person is exhibiting the form indicated by the held image information.

Further, some of the predetermined motions to be detected include motions, such as the motion of looking around, which are difficult to determine on the basis of one still image. In this case, the sensing unit 13 is able to detect such a predetermined motion by tracking a person among a plurality of images and detecting change in the human form as described above. For example, the sensing unit 13 is able to detect a motion of looking around by detecting change in the direction of the head through the person tracking. In addition, a motion of going back and forth is also an example of a motion which is difficult to determine on the basis of one still image. The sensing unit 13 is able to detect this motion in the following manner. For example, while holding image feature information of a person detected once, the sensing unit 13 recognizes that the person disappears from the video, and recognizes again that the person has returned in the video. The sensing unit 13 counts the number of events of the detected person appearing and disappearing, and detects the motion of going back and forth in a case where the number is greater than a predetermined number.

The sensing unit 13 may detect a more detailed predetermined motion in accordance with the installation position of the surveillance camera 9, the number of pixels (image resolution) of the surveillance camera 9, and the like. For example, the sensing unit 13 may detect a motion of the eyes darting back and forth, a motion of the mouth continuously talking to oneself, a motion of the face showing anger, and the like, as the predetermined motions.

The specific contents of the predetermined motion detected by the sensing unit 13 and the method of detecting the predetermined motion are not limited to the above-mentioned example.

Whenever detecting a predetermined motion, the sensing unit 13 generates information to be stored in the detection information storage unit 15. For example, the sensing unit 13 generates the identification information of the surveillance camera 9 that captures images of the detected predetermined motion, a time when the detected predetermined motion is captured, image data of a person whose motion is detected as a predetermined motion, image feature information of the person, and the like. The time can be determined from, for example, time information of an image (image frame) in which the predetermined motion is detected. The generated image data may be an image including the face of the person whose motion is detected as a predetermined motion, or may be generated by extracting a partial region including the face of the person from the image. The image feature information is generated, for example, by a method which is used at the time of tracking the person or the like.

For example, whenever the sensing unit 13 detects a predetermined motion, the sensing unit 13 notifies the storage processing unit 14 of the detected motion, together with the above-mentioned information to be stored in the detection information storage unit 15. In a case where it is possible to recognize that one or more of multiple types of predetermined motions of the same person are detected a plurality of times through the person tracking or the like, the sensing unit 13 may give a notification of information indicating whether or not it is the same person whenever a predetermined motion is detected. Further, the sensing unit 13 sequentially generates the above-mentioned information whenever the predetermined motion is detected during a period from the start to the end of the tracking of the same person, and notifies the storage processing unit 14 of the detected motion together with all of the generated pieces of information after the tracking has ended.

Further, in a case where a location and a time at which the predetermined motion is detected are not to be stored in the detection information storage unit 15, it is not necessary for the sensing unit 13 to generate information of the above-mentioned location and time whenever a predetermined motion is detected. The sensing unit 13 is only required to notify the storage processing unit 14 of the image and the image feature information of the person whose motion is detected as a predetermined motion whenever the predetermined motion is detected. Further, the sensing unit 13 may notify the storage processing unit 14 of the detected number of times together with the image and the image feature information of the person after the tracking of the same person is terminated. Furthermore, in a case where the image feature information is not to be stored in the detection information storage unit 15, the sensing unit 13 may send only the image of the person whose motion is detected as a predetermined motion to the storage processing unit 14.

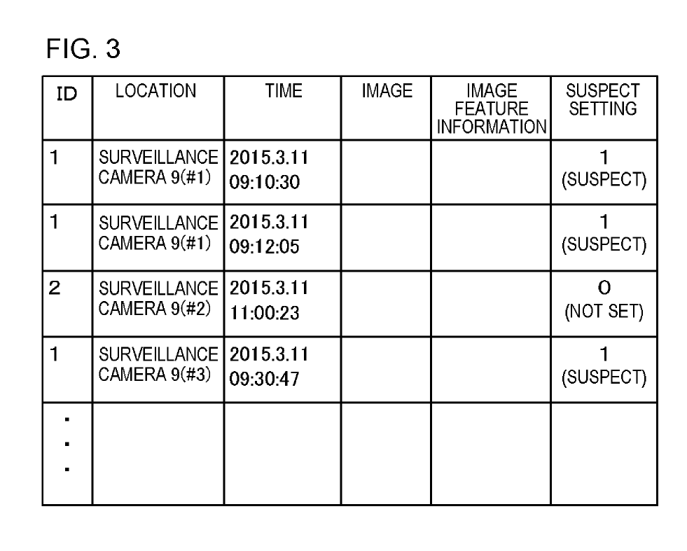

The detection information storage unit 15 stores the detection information such that each person whose motion is detected as a predetermined motion by the sensing unit 13 can be specified and the detected number of times of the predetermined motion can be acquired for each person. The contents of the detection information stored in the detection information storage unit 15 and the storage format thereof are not limited. For example, as in the example shown in FIG. 3, the detected number of times of the predetermined motion may be acquired from the number of records, may be acquired from the detected number of times included in each record, or may be acquired from a combination of both. Further, as the information which allows to determine each person, image data or image feature information of each person is stored. As information allowing to identify each person, instead of the image data and the image feature information, information indicating the location and the time at which the detected predetermined motion is performed, and information (gender, age group, color of clothing, and the like) indicating the feature of each person extracted from the image, may be stored.

FIG. 3 is a diagram illustrating an example of a detection information storage unit 15 according to the first example embodiment. In the example of FIG. 3, the detection information storage unit 15 is a table that stores records, each including the ID, the location, the time, the image, the image feature information, and data of a field for setting a suspect. In the example of FIG. 3, one record stored in the detection information storage unit 15 indicates the contents of a single detection of a predetermined motion. In the ID field, ID data for identifying each person whose motion is detected as a predetermined motion is set. However, in some cases, in the ID data to be set, each person may not be accurately identified. In other words, different IDs may be given to pieces of information of the same person, and may be stored in different records. Details thereof will be described later.

In the location field, data determining the location where the detected predetermined motion has been performed is set. In the example of FIG. 3, in the location field, identification information of the surveillance camera 9 which has captured an image in which a predetermined motion is detected is set as data for determining the location. In the time field, data indicating the time when the detected predetermined motion is performed is set. In the image field, an image of a person whose motion is detected as a predetermined motion is stored. Since the stored image is used for display, it is preferable that the stored image is an image in which the head of the detected person is enlarged. In the image feature information field, a feature value of the image of the person, whose motion is detected as a predetermined motion, is set. In the suspect setting field, information (0 or 1) indicating whether or not the detected person is set as a suspect, is set by a setting unit 16 to be described later. Hereinafter, a state in which the “information (1) indicating that the detected person is set as a suspect” is set in the suspect setting field may be described as “a suspect flag is ON” or “a suspect flag is set”. When a record is to be added, the suspect flag is not set, that is, an initial value of the suspect setting field is information (0) indicating that the detected person is not set as the suspect. In the example of FIG. 3, the ID, the location, the time, and the image are stored as information allowing to identify a person, and the detected number of times can be acquired from the number of records including the same ID.

In a case where the sensing unit 13 detects any one of the multiple types of predetermined motions, the storage processing unit 14 acquires information relating to the detection from the sensing unit 13, and stores the information in the detection information storage unit 15.

In the example of FIG. 3, the storage processing unit 14 adds a new record to the detection information storage unit 15 whenever any one of the multiple types of predetermined motions is detected by the sensing unit 13. Whenever a predetermined motion is detected, the storage processing unit 14 may receive a notification of the effect of the detection from the sensing unit 13. Further, the storage processing unit 14 may collectively acquire all pieces of the detection information of a certain person during the tracking from the sensing unit 13, at the time point at which the tracking of the person is terminated in the sensing unit 13. In this case, the storage processing unit 14 may store a plurality of records in the detection information storage unit 15 at the time point at which the person tracking is terminated.

However, each record of the detection information storage unit 15 may include a field of the detected number of times. In this case, the storage processing unit 14 may add a new record to the detection information storage unit 15 at the time point at which the tracking of a certain person is terminated in the sensing unit 13. The storage processing unit 14 itself may count the detected number of times of the predetermined motion during a period from the start to the end of the tracking of the certain person, and may acquire the detected number of times from the sensing unit 13. The storage processing unit 14 sets the detected number of times in the added record.

The storage processing unit 14 determines the ID to be set in each record of the detection information storage unit 15 in the following manner. In a case where the storage processing unit 14 receives information indicating detection of the predetermined motion of the same person from the sensing unit 13, on the basis of the information, the storage processing unit 14 assigns the same ID to the records indicating detection of the same person. On the other hand, in a case where such information is not received from the sensing unit 13, the storage processing unit 14 may respectively assign different IDs to the records. In both cases in the above description, there is high possibility that different IDs are given to predetermined motions performed by the same person. Even in the sensing unit 13 performing the person tracking, it is not always possible to determine that predetermined motions detected from images captured at different time zones or on different days are each motions of the same person.

On the other hand, predetermined motions detected during automatic tracking of a certain person are highly likely to be motions of the same person. Therefore, afield indicating an accuracy of the ID set in each record may be provided in the detection information storage unit 15. For example, in a case of receiving information indicating detection of the predetermined motions of the same person from the sensing unit 13, the storage processing unit 14 assigns the same ID to the records indicating detection of the same person, and further sets flags, each of which indicates that the accuracy is high, in each accuracy field. Further, in a case where the field of the detected number of times is provided in each record, there is a high possibility that each record stores the information of the same person.

In the example of FIG. 3, the storage processing unit 14 acquires the identification information of the surveillance camera 9 corresponding to the image in which the predetermined motion is detected, from the sensing unit 13, and sets the identification information in the location field of the detection information storage unit 15. The storage processing unit 14 holds in advance a table in which identification information of the surveillance camera 9 and identification information for identifying the location are stored in association with each other, and stores the identification information of the location extracted from the table in the detection information storage unit 15, instead of the identification information of the surveillance camera 9.

In the example of FIG. 3, the storage processing unit 14 acquires an imaging time of the detected predetermined motion from the sensing unit 13, and sets the imaging time in the time field of the detection information storage unit 15.

The storage processing unit 14 acquires the image data and the image feature information of the person whose motion is detected as a predetermined motion from the sensing unit 13, and stores the image data and the image feature information in the image field and the image feature information field of the detection information storage unit 15. The image data and the image feature information stored in each record of the detection information storage unit 15 are information for displaying and recognizing the same person. Accordingly, in each of these fields, it is preferable that a plurality of pieces of image data and a plurality of pieces of image feature information indicating the same person are stored in order to cope with various aspects and clothing.

Further, the storage processing unit 14 sets a suspect flag (1) in the suspect setting field of the record, which corresponds to the person set as the suspect by the setting unit 16, among all the records stored in the detection information storage unit 15. At this time, the storage processing unit 14 acquires the ID, which corresponds to the person set as the suspect, from the setting unit 16, and is able to determine the record to be subjected to the above-mentioned setting using the ID.

By referring to the detection information storage unit 15, the setting unit 16 acquires the detected number of times of a person whose motions are detected as one or more types of predetermined motions by the sensing unit 13, and determines a suspect among the persons indicated by the information stored in the detection information storage unit 15, on the basis of this detected number of times. The suspect is as described above, and in the present example embodiment, the setting unit 16 determines a suspect shoplifter as the suspect.

On the basis of the information for determining each person in the information stored in the detection information storage unit 15, the setting unit 16 determines records, which are presumed to indicate the same person, in records to which different IDs are given, among all the records stored in the detection information storage unit 15. For example, the setting unit 16 determines records, which are presumed to indicate the same person, by comparing the image data or the image feature information stored in the detection information storage unit 15, or both, among records in which different IDs are set. Records, in which degrees of similarity between pieces of image data or pieces of image feature information are higher than a predetermined threshold value, are determined as records which are presumed to indicate the same person, and the setting unit 16 updates the ID fields of the respective records to the same ID.

In addition to the above-mentioned image data and image feature information, the setting unit 16 may determine records, which are presumed to indicate the same person, by further comparing the information of the location and the time stored in the detection information storage unit 15 among the records. For example, when the degree of similarity of the image data or the image feature information is a certain level although lower than the predetermined threshold value (in the case where the degree of similarity is higher than a predetermined lower limit threshold value), the setting unit 16 may presume that the records indicate the same person when the locations and the times are close.

Further, the image data and the image feature information may not be stored, and the detection information storage unit 15 may store information indicating the feature of each person extracted from the location, the time, and the image as information (gender, age group, color of clothing, and the like) for determining each person. In this case, the setting unit 16 may determine records, which are presumed to indicate the same person, by comparing the information indicating the location, the time, and the feature of each person, among the records in which different IDs are set. It is possible to presume that the records indicating close locations, close times, and the same features indicate the same person.

Further, as described above, the setting unit 16 does not have to determine records, which are presumed to indicate the same person, among the records to which different IDs are given. This is a case where it is determined that records to which different IDs are given are information of different persons. In this case, it is determined whether the pieces of information are for the same person in a range that can be recognized by the detection processing (such as person tracking) performed by the sensing unit 13.

The setting unit 16 determines records including the same ID among the records stored in the detection information storage unit 15, and counts the detected number of times of the person indicated by the ID on the basis of the determined records. In the example of FIG. 3, the setting unit 16 counts the number of records including the same ID as the detected number of times. Further, in a case where the detected number of times is included in each record, the setting unit 16 calculates the detected number of times by adding up the numbers of times of detection.

The setting unit 16 determines a person whose calculated detected number of times is greater than a predetermined number of times held in advance as a suspect. The predetermined number of times held in advance is appropriately determined depending on the type of the suspect. For example, in a case where a suspect shoplifter is a suspect to be determined, since shoplifting is said to be addictive, the predetermined number of times is set to approximately 10 times. However, a specific numerical value of the predetermined number of times is not limited.

The setting unit 16 notifies the storage processing unit 14 of the ID indicating the person determined as a suspect, thereby causing the storage processing unit 14 to set the value of the suspect setting field of the record in which the ID is set. The setting unit 16 may operate whenever a new record is added to the detection information storage unit 15, or may operate at a predetermined cycle.

The detection unit 17 detects a person presumed to be a suspect from the video, on the basis of the record in which the suspect flag (1) is set in the record stored in the detection information storage unit 15. This video may be a real-time video acquired from the surveillance camera 9 by the acquisition unit 11, or an image (including a recorded image) stored in the image storage unit 12. Specifically, the detection unit 17 detects an image region indicating the person, from the original video by the same method as that of the sensing unit 13, and calculates a degree of similarity between the image feature information of the image region and the image feature information included in the record. In a case where the degree of similarity is greater than a predetermined threshold value, the detection unit 17 is able to detect that the original video includes a person presumed to be a suspect.

The output processing unit 19 notifies detection of the person presumed to be a suspect by the detection unit 17. The notification method may be any method as long as the method is able to notify that a person presumed to be a suspect is detected. For example, the output processing unit 19 transmits an e-mail to the effect of the detection to an e-mail address registered in advance. Further, the output processing unit 19 may cause the display processing unit 18 to be described later to display to the effect of the detection, may turn on a lighting apparatus such as a patrol lamp or a light emitting diode (LED) lamp, and may output a sound. This notification may be implemented by a display of the display processing unit 18 as described later. The output processing unit 19 and the display processing unit 18 may be referred to as notification units.

The display processing unit 18 causes the display apparatus 7 to display the image captured by each surveillance camera 9 which is stored in the image storage unit 12. Further, the display processing unit 18 may cause the display apparatus 7 to display the image acquired by the acquisition unit 11. For example, the display processing unit 18 may cause the display apparatus 7 to constantly display a video captured by the surveillance cameras 9, or may cause the display apparatus 7 to display a video stored in the image storage unit 12 (which may be a recorded video).

In addition, the display processing unit 18 causes the display apparatus 7 to display a video including a person set as a suspect added with information allowing to identify the person set as a suspect in the video. The video having the information added thereto can be displayed in various forms.

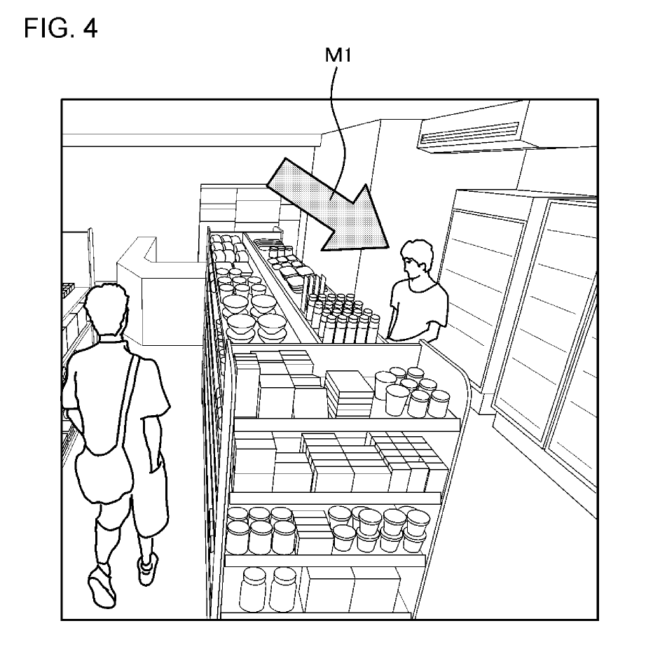

FIG. 4 is a diagram illustrating a first example of a display. In the example of FIG. 4, an arrow M1 is added as information allowing to identify a person. The arrow is disposed to point to the person set as the suspect.

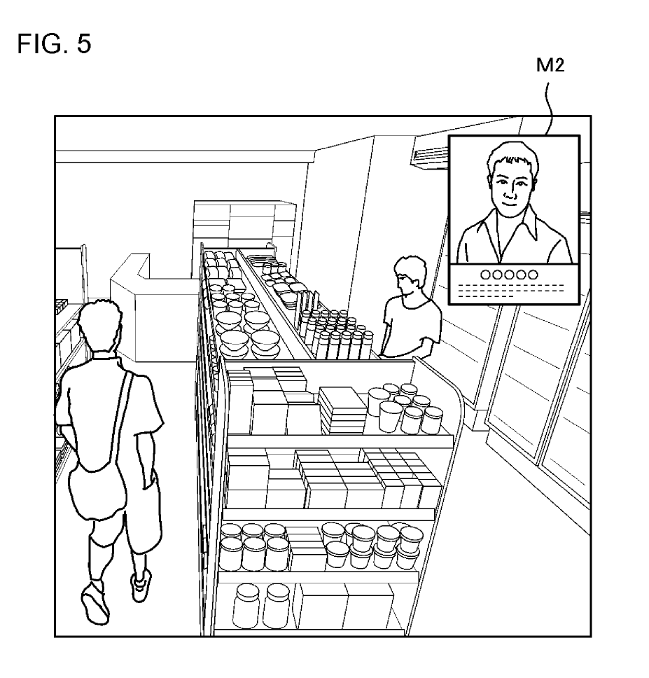

FIG. 5 is a diagram illustrating a second example of the display. In the example of FIG. 5, image data M2 stored in the record of the detection information storage unit 15 is added as information allowing to identify a person. In the example of FIG. 5, in addition to the image data M2, other information (a detection history including a location, a time, and the like) stored in the record is also displayed.

The original video to which information allowing to identify a person set as a suspect is added may be a still image or a moving image in which the detected predetermined motion appears, or may be a real-time video or a recorded video obtained from the surveillance camera 9. For example, the display processing unit 18 extracts the location data and the time data from the record which is stored in the detection information storage unit 15 and in which the suspect flag (1) is set, and extracts a still image or a moving image, which corresponds to the imaging location and the imaging time indicated by the data, from the image storage unit 12. The display processing unit 18 adds information allowing to identify the suspect to the extracted still image or moving image, and displays the obtained image on the display apparatus 7. At this time, the display processing unit 18 may detect the image region corresponding to the suspect in the original still image or moving image by using the image feature information included in the record of the detection information storage unit 15.

Further, in a case where the detection unit 17 detects a person presumed to be a suspect, the display processing unit 18 may display a video, in which the information allowing to identify the detected person is added to a video used for the detection, on the display apparatus 7. For example, the display processing unit 18 can acquire the position information within the image of the person detected from the detection unit 17, and add information, through which the person indicated by the above-mentioned arrow can be determined, at the position indicated by the position information. In addition, the display processing unit 18 may acquire the ID of the record of the detection information storage unit 15 which is the basis for presuming the detected person from the detection unit 17, extract the image data from the record of the detection information storage unit 15 on the basis of the ID, and add the image data to the original video.

Further, the display processing unit 18 may display a list of suspects which includes images of suspects on the display apparatus 7, on the basis of the record which is stored in the detection information storage unit 15 and in which the suspect flag (1) is set. Information on one suspect included in this list display is extracted from a record in which the suspect flag (1) is set and the same ID is included. The information on one suspect included in the list display is one or more pieces of information selected from information (including image data) stored in a plurality of records.

### [Operation Example and Surveillance Method]

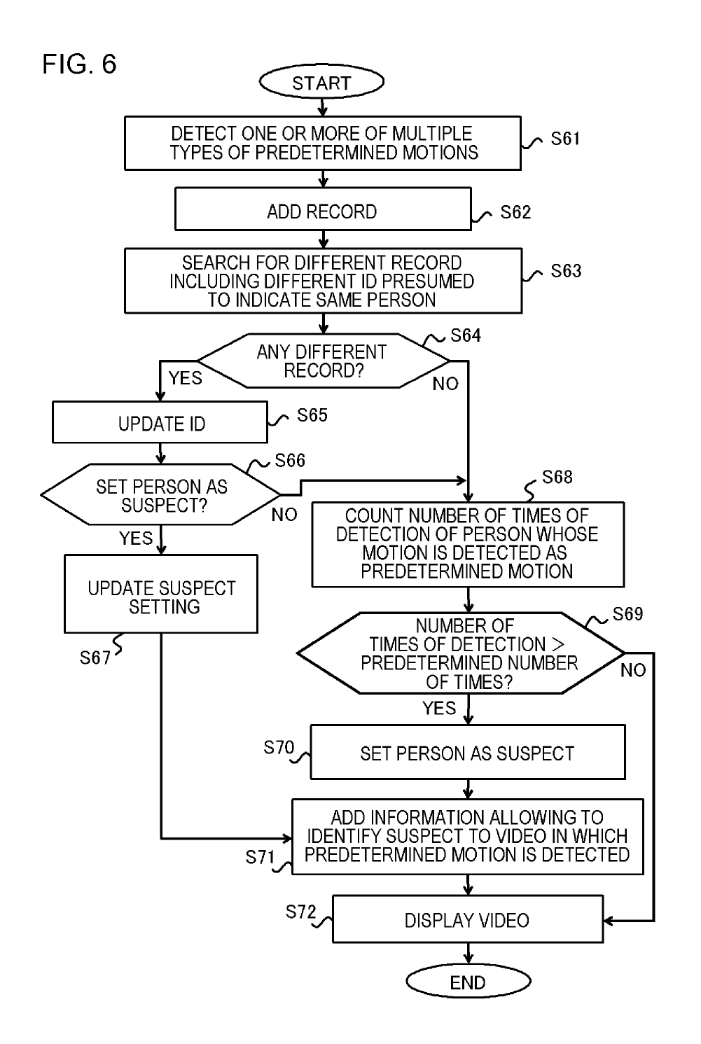

Hereinafter, a surveillance method according to the first example embodiment will be described with reference to FIGS. 6, 7, and 8. FIGS. 6, 7, and 8 are flowcharts illustrating operation examples of the surveillance control apparatus 10 according to the first example embodiment. As shown in FIGS. 6, 7, and 8, the surveillance method is executed by at least one computer such as the surveillance control apparatus 10. Each step shown in the drawing is executed by each processing module of the surveillance control apparatus 10, for example. Since each step is the same as the above-mentioned processing contents of each processing module of the surveillance control apparatus 10, details of each step will not be repeated.

FIG. 6 shows an operation example in a case of displaying a video, to which setting of a suspect and the information allowing to identify the suspect are added, in response to the detection of the predetermined motion as a trigger. Since the operation shown in FIG. 6 is performed for each surveillance camera 9, in the following description, a video obtained from one surveillance camera 9 will be explained.

The surveillance control apparatus 10 acquires the video from the surveillance camera 9, and detects one or more of multiple types of predetermined motions of a person appearing in the video (S61). As described above, the surveillance control apparatus 10 holds in advance the information necessary for detecting the person in the video and the information necessary for detecting each type of the predetermined motion. The method of detecting the predetermined motion through the surveillance control apparatus 10 is as described above.

The surveillance control apparatus 10 adds a record including information on detection in (S61) to the detection information storage unit 15 (S62). The information on the detection is stored in the detection information storage unit 15 such that each person whose motion is detected as a predetermined motion can be determined and the detected number of times of the predetermined motion can be acquired for each person. The detection information stored in the detection information storage unit 15 is as described above. As described above, the surveillance control apparatus 10 may execute the process of (S62) whenever a predetermined motion is detected, and may execute the process of (S62) at every detection during a period from the start to the end of the image tracking, at the time when the image tracking of the same person is ended. Hereinafter, an example of the detection information storage unit 15 shown in FIG. 3 will be described, assuming one record is added to the detection information storage unit 15 in (S62).

The surveillance control apparatus 10 checks (S63) whether or not the detection information storage unit 15 stores another record including an ID different from the ID newly added in (S62) and presumed to indicated a person whose motion is detected as a predetermined motion in (S61). This check is performed using image feature information or image data included in each record, or other information (the location, the time, and the like). This checking method is the same as the processing contents of the setting unit 16. When the other record exists (S64; YES), the surveillance control apparatus 10 replaces the ID of the record added in (S62) with the ID which is set in the other record (S65). Further, when the suspect flag (1) is set (S67) in the other record (S66; YES), the surveillance control apparatus 10 sets the suspect flag (1) in the record, which is added in (S62). That is, the surveillance control apparatus 10 determines that the person whose motion is detected as a predetermined motion in (S61) can be presumed to be the same as the person set in advance as the suspect from the detected number of times in the past.

When the other record does not exist (S64; NO), or when the suspect flag (1) is not set in the other record (S66; NO), the surveillance control apparatus 10 executes the process of (S68). In (S68), the surveillance control apparatus 10 counts the detected number of times of the person whose motion is detected as a predetermined motion in (S61). According to the example of FIG. 3, the surveillance control apparatus 10 counts the number of records, which includes the ID indicating the person whose motion is detected as a predetermined motion in (S61), as the detected number of times.

The surveillance control apparatus 10 determines whether or not the detected number of times counted in (S68) is greater than a predetermined number of times (S69). The predetermined number of times is held in advance. When the detected number of times is equal to or less than the predetermined number of times (S69; NO), the surveillance control apparatus 10 determines that the person is not a suspect and displays a video as it is (S72). On the other hand, when the detected number of times is greater than the predetermined number of times (S69; YES), the surveillance control apparatus 10 sets the person as a suspect (S70). Specifically, the surveillance control apparatus 10 sets the suspect flag (1) in the fields for setting the suspect of the record added in (S62) and the other record determined since it indicates the same person.

The surveillance control apparatus 10 adds information allowing to identify a person whose motion is detected as a predetermined motion, that is, a person set as a suspect, to the video in which the predetermined motion is detected (S71). The surveillance control apparatus 10 displays the video to which the information is added (S72). The information, through which a person set as a suspect can be determined, may be the arrow image indicating the person as exemplified in FIG. 4, and may be image data of the person whose motion is detected as a predetermined motion as exemplified in FIG. 5.

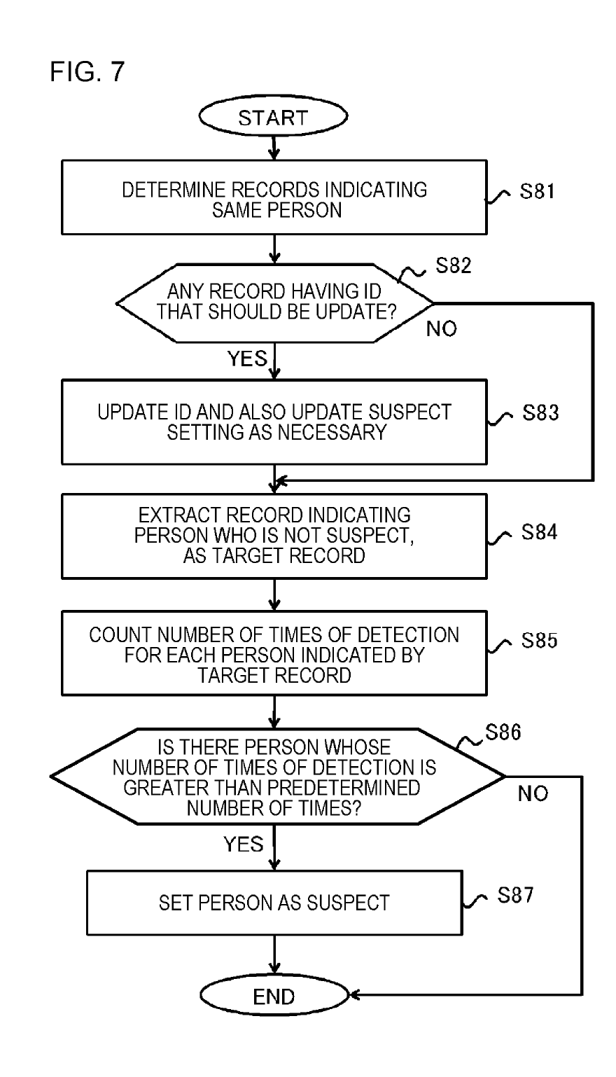

FIG. 7 shows an operation example in the case where setting of the suspect of the record stored in the detection information storage unit 15 is updated at an arbitrary timing. In the example of the motion shown in FIG. 6 described above, the suspect is set in response to the detection of the predetermined motion as a trigger. However, the surveillance method according to the first example embodiment is not limited to the example shown in FIG. 6. For example, while only (S61) and (S62) of FIG. 6 are executed, the operation shown in FIG. 7 may be executed in parallel therewith.

The surveillance control apparatus 10 determines records, which are presumed to indicate the same person and to which different IDs are given, among all the records stored in the detection information storage unit 15 (S81). The surveillance control apparatus 10 determines records, which are presumed to indicate the same person, by using information for determining each person in the information included in each record to which different IDs are attached. This determination method is the same as the processing contents of the setting unit 16.

When there are records provided with different IDs but indicating the same person, that is, when there are records whose IDs should be updated (S82; YES), the surveillance control apparatus 10 updates the IDs of the records, which are determined as indicating the same person, to the same ID (S83). Further, the surveillance control apparatus 10 also updates a value of the suspect setting field as necessary (S83). Specifically, when records in which the suspect flag (1) is set and records in which the suspect flag (1) is not set are mixed in the determined records, the surveillance control apparatus 10 sets the suspect flag (1) in all the determined records.

Subsequently, the surveillance control apparatus 10 extracts records which indicate persons who are not suspects as target records from the detection information storage unit 15 (S84). That is, the records in which the suspect flag (1) is not set are extracted as target records.

The surveillance control apparatus 10 counts the detected number of times for each of persons indicated by the extracted target records (S85). According to the example of FIG. 3, the surveillance control apparatus 10 counts the number of records for each ID.

The surveillance control apparatus 10 determines whether or not there is a person (ID) for which the detected number of times counted in (S85) is greater than a predetermined number of times (S86). The predetermined number of times used herein is the same as the predetermined number of times used in (S69) of FIG. 6. The surveillance control apparatus 10 sets each person, for which the detected number of times is greater than a predetermined number of times, as a suspect (S87). Specifically, the surveillance control apparatus 10 sets the suspect flag (1) in all the records including the ID of the person for which the detected number of times is greater than the predetermined number of times.

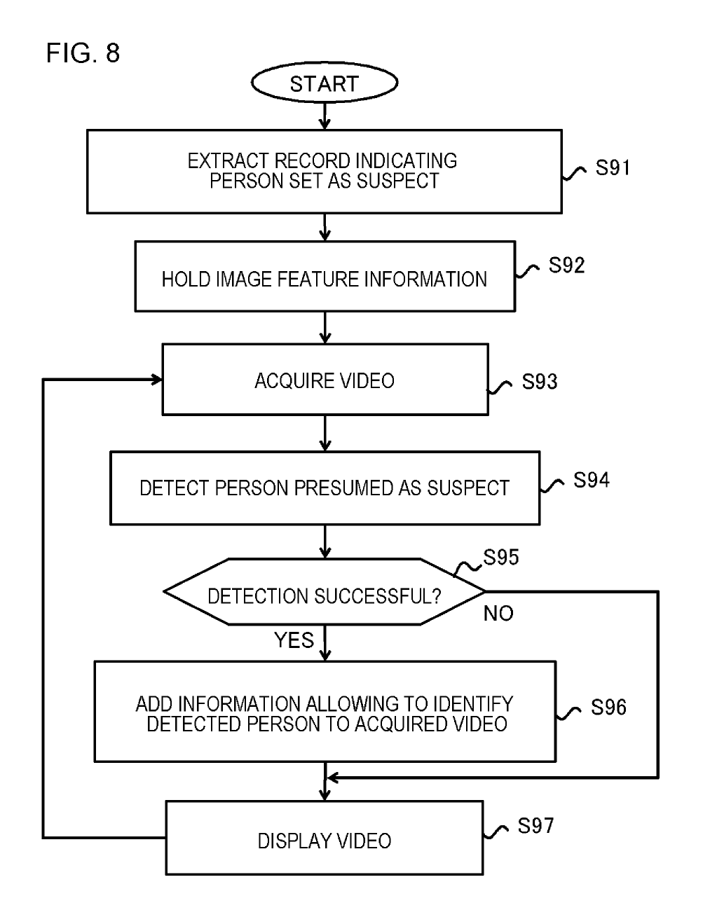

FIG. 8 shows an operation example of detecting, from the video, a person presumed as a person who has already been set as a suspect in the detection information storage unit 15. In FIG. 6, information allowing to identify the suspect is added to the video in which the predetermined motion is detected. However, the surveillance method according to the first example embodiment is not limited to the example shown in FIG. 6. For example, while only the steps (S61) and (S62) of FIG. 6 are executed, the operation shown in FIG. 7 and the operation shown in FIG. 8 may be executed in parallel therewith.

The surveillance control apparatus 10 extracts a record indicating a person set as a suspect from the detection information storage unit 15 (S91). In other words, the surveillance control apparatus 10 extracts the record in which the suspect flag (1) is set. The surveillance control apparatus 10 holds the image feature information included in the extracted record (S92).

The surveillance control apparatus 10 acquires a video (S93). This video may be a real-time video acquired from the surveillance camera 9, and may be an image (also including a recorded image) stored in the image storage unit 12.

Using the image feature information held in (S92), the surveillance control apparatus 10 detects a person (S94) who is presumed to be a suspect in the video acquired in (S93). This detection method is the same as the processing contents of the detection unit 17.

When the surveillance control apparatus 10 detects a person presumed to be a suspect in the video (S95; YES), the surveillance control apparatus 10 adds information allowing to identify the detected person to the video (S96). For example, on the basis of the position information in the video of the detected person, the surveillance control apparatus 10 is able to add information allowing to determine that person, such as the above-mentioned arrow to the position indicated by the position information. Further, the surveillance control apparatus 10 may add the image feature information which is set as the basis for the detection in (S94) and image data which is included in the same record to the original video.

When the person presumed to be a suspect in the video is detected (S95; YES), the surveillance control apparatus 10 displays the video (S97) to which the information is added in (S96). When the person is not detected (S95; NO), the video acquired in (S93) is displayed as it is (S97).

The surveillance control apparatus 10 executes (S93) to (S97) at a predetermined cycle (frame period) while continuously displaying the video. Further, (S91) and (S92) may be executed asynchronously with the execution timing of (S93) to (S97).

### [Advantages and Effects of First Example Embodiment]

As described above, in the first example embodiment, a person is detected from the acquired image, and at least one of multiple types of predetermined motions of the person is detected. These predetermined motions are set as motions which are continuously performed by a suspect and can be distinguished from motions of an ordinary person. For example, in a case where a suspect shoplifter is a suspect to be determined, a suspicious motion that a shoplifter is likely to perform is set as a predetermined motion. Then, information indicating the person, whose motion is detected as at least one of the multiple types of predetermined motions, is set as a candidate for the suspect in association with the detected number of times, and is stored in the detection information storage unit 15. In the first example embodiment, among candidates of the suspects indicated by the information stored in the detection information storage unit 15, a person, for which the detected number of times is greater than a predetermined number of times, is set as a suspect.

As described above, according to the first example embodiment, even when a suspicious motion likely to be performed by a shoplifter is detected, a person who performs the motion is not immediately determined as a suspect on the basis of the detection alone. Thereby, even when an ordinary person who is not a suspect accidentally performs the suspicious motion, the ordinary person is hardly determined as a suspect. The reason for this is that an ordinary person is not considered to perform the suspicious motion with high frequently. On the other hand, since criminal acts such as shoplifting and molesting are habitual, a suspect relating to such a crime is highly likely to repeat the suspicious motion. According to the first example embodiment, since a person for which the detected number of times of suspicious motion is greater than the predetermined number of times is set as a suspect, it is possible to reduce erroneous determination of the suspect and to improve the accuracy of determination of the suspect.

Further, in the first example embodiment, a video is displayed, in which information allowing to identify the person set as the suspect in the video is added to the video in which the predetermined motion is detected. A viewer of this video is able to easily recognize whether or not there is a person who is highly likely to be a suspect by the presence or absence of the added information. Furthermore, the viewer is able to immediately know that there is a person who is determined as a person highly likely to be a suspect since the predetermined detected number of times of the predetermined motion thereof is greater than the predetermined number of times, and is able to immediately know the information allowing to identify the person. In such a manner, it is possible to take various countermeasures such as catching the suspect by acquiring the proof of the crime or preventing a crime by speaking to the suspect at an earlier point in time.

Furthermore, in the first example embodiment, the suspect is determined in the information stored in the detection information storage unit 15, and a person presumed to be the suspect is detected from the video on the basis of the information (image feature information or the like) indicating the person set as the suspect. Then, notification that the person presumed to be a suspect has been detected is made. As one of the notification methods, a video, to which the information allowing to identify the detected person is added, is displayed on the video. Thereby, even when the suspect does not perform a suspicious motion (predetermined motion) in the video, a viewer of the video is made to immediately recognize the presence of the person who is marked since the person is highly likely to be a suspect on the basis of past behavior history, and information about the person.

In addition, in the first example embodiment, on the basis of the information stored in the detection information storage unit 15, a list of suspects including an image of each suspect is displayed. That is, according to the first example embodiment, it is possible to generate and output a black list.

### Second Example Embodiment

In the first example embodiment, the suspect is set on the basis of the total detected number of times regardless of the type of the detected predetermined motion. However, depending on the type of the predetermined motion, the degree of the likelihood of being a suspect may differ. For example, if a suspect shoplifter is the suspect to be determined, a motion of looking up toward the ceiling (motion of checking the presence of surveillance cameras) has a higher possibility of being performed by a suspect than a motion of looking at a product held in the person's hand. Therefore, the surveillance control apparatus 10 according to the second example embodiment manages the type of the predetermined motion to be detected. Hereinafter, the surveillance system 1 according to the second example embodiment will be described focusing on contents different from those in the first example embodiment. In the following description, contents the same as those of the first example embodiment will not be repeated.

### [Processing Configuration]

The surveillance control apparatus 10 according to a second example embodiment has the same processing configuration as that of the first example embodiment.

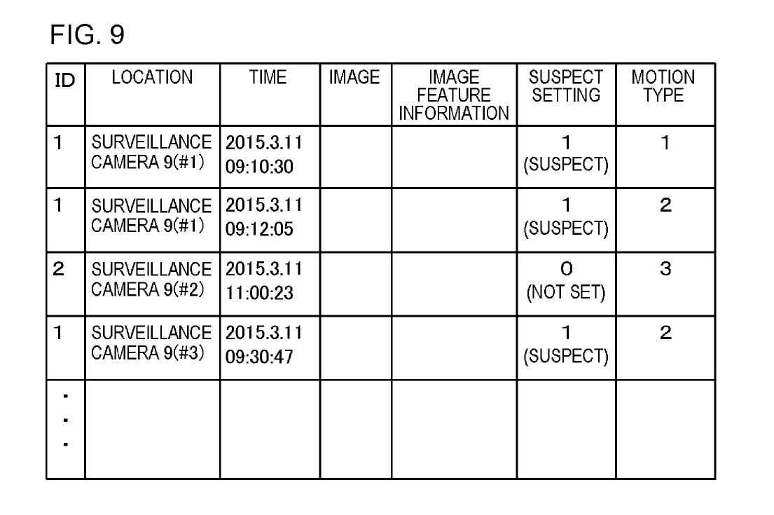

FIG. 9 is a diagram illustrating an example of a detection information storage unit 15 according to the second example embodiment. As shown in FIG. 9, the record of the detection information storage unit 15 in the second example embodiment further includes a motion type field. In the motion type field, identification information of the type of the detected predetermined motion is set.

The sensing unit 13 holds in advance identification information on each of multiple predetermined kinds to be detected, and determines identification information of the type of the detected predetermined motion in accordance with the detection of the predetermined motion.

When adding a record to the detection information storage unit 15, the storage processing unit 14 sets the identification information of the motion type, which is determined by the sensing unit 13, in the record.

By referring to the detection information storage unit 15, the setting unit 16 counts the detected number of times for each type of the predetermined motions of each person, and determines a suspect among persons indicated by the information stored in the detection information storage unit 15, on the basis of the counted detected number of times for each motion type.

For example, the setting unit 16 compares the counted detected number of times for each motion type with a predetermined number of times for each motion type. In this case, the setting unit 16 holds in advance a predetermined number of times as a threshold value, for each motion type of the predetermined motions. Each predetermined number of times may be different for each motion type, and may partially include the same number of times, unless the number of times is the same for all motion types. Each predetermined number of times can be determined in accordance with the degree of the likelihood of being a suspect for each motion type of the predetermined motions. The predetermined number of times corresponding to the motion type of the predetermined motion with a high likelihood of being performed by a suspect is set to a small value. For example, the predetermined number of times of the motion of looking at a product held in the person's hand is set to 10 times, and the predetermined number of times of the motion of looking up toward the ceiling (motion of checking the presence of surveillance cameras) is set to 5 times.

The setting unit 16 may set the person as a suspect when there is even one motion type whose detected number of times is greater than the predetermined number of times among the predetermined motions detected for the same person. Further, the setting unit 16 may set the person as a suspect in a case where the number of type of motions whose detected number of times is greater than the predetermined number of times is greater than a predetermined threshold value (for example, a half of all motion types or the like). According to this setting method, it is possible to further improve the accuracy of determination of the suspect. Further, in addition to the comparison between the detected number of times for each motion type and the predetermined number for each motion type, as in the first example embodiment, the setting unit 16 may compare the total detected number of times with the predetermined number. More specifically, in a case where the result of comparison between the detected number of times for each motion type and the predetermined number of times for each motion type satisfies the above-mentioned conditions and the total detected number of times is greater than the predetermined number of times, the setting unit 16 may set the person as a suspect. In this method, it is also possible to improve the accuracy of determination of the suspect.

In addition, the setting unit 16 may determine a suspect (subject) on the basis of the score obtained by weighting the detected number of times for each type of the predetermined motions of each person in accordance with each type of the predetermined motions. In this case, the setting unit 16 holds a predetermined weight value (coefficient) for each type of the predetermined motions. Each weight value is determined in accordance with the degree of likelihood of being a suspect for each type of the predetermined motions. The weight value corresponding to the type of the predetermined motion with a high likelihood of being performed by a suspect is set as a large value. The setting unit 16 calculates a score for each motion type by multiplying the detected number of times by the weight value for each type of the predetermined motions. For example, the setting unit 16 sets the person as a suspect in a case where the total score obtained by adding up the scores for each type is greater than a predetermined threshold value. The predetermined threshold value to be compared with the total score is determined by simulation or the like, and is held in advance.

Further, the setting unit 16 may compare the score for each motion type with a predetermined threshold value according to each motion type. In this case, the setting unit 16 may set the person as a suspect when there is even one motion type whose score is greater than the predetermined threshold value thereof. Further, the setting unit 16 may set the person as a suspect in a case where the number of motion types whose scores according to the motion types is greater than predetermined threshold values thereof is greater than a certain predetermined threshold value (for example, a half of all motion types or the like).

Further, the setting unit 16 may determine a suspect in consideration of either one or both of the result of comparison between the total score and the predetermined threshold value and the result of comparison between the score for each motion type and the predetermined threshold value for each motion type. The setting unit 16 may determine a suspect in consideration of one or both, or the result of comparison between the total detected number of times and the predetermined number of times in the first example embodiment.

### [Motion Example and Image Surveillance Method]

Hereinafter, a surveillance method according to the second example embodiment will be described with reference to FIGS. 6 and 7. The entity of execution of the surveillance method according to the second example embodiment is the same as that of the first example embodiment. Further, each step included in the surveillance method according to the second example embodiment is the same as the processing contents of each processing module of the surveillance control apparatus 10, and thus details of each step will not be repeated.

In the second example embodiment, the contents of (S62), (S68), and (S69) in FIG. 6 are different from those in the first example embodiment.

In (S62), the surveillance control apparatus 10 adds a record including identification information of the type of the predetermined motion detected in (S61) to the detection information storage unit 15.

In (S68), the surveillance control apparatus 10 counts the detected number of times for each predetermined motion type for the person whose motion is detected as a predetermined motion. Specifically, the surveillance control apparatus 10 counts the number of records having identification information of the same motion type among the records including the ID indicating the person whose motion is detected as a predetermined motion in (S61), for each motion type. However, in (S68), as in the first example embodiment, the surveillance control apparatus 10 may further count the total detected number of times of the person whose motion is detected as a predetermined motion.

In (S69), the surveillance control apparatus 10 determines the above-mentioned conditions for the setting unit 16. The surveillance control apparatus 10 may add the same conditions as those in the first example embodiment (conditions in which the total detected number of times is greater than a predetermined number of times) to the above-mentioned conditions.

In the second example embodiment, the contents of (S85) and (S86) in FIG. 7 are different from those in the first example embodiment.

In (S85), the surveillance control apparatus 10 counts the detected number of times for each type of the predetermined motions for each person indicated by the target record extracted in (S84). More specifically, the surveillance control apparatus 10 counts the number of records having the identification information of the same motion type for each record group including the same ID. However, in (S85), as in the first example embodiment, the surveillance control apparatus 10 may further count the detected number of times for each person indicated by the extracted target record.

In (S86), the surveillance control apparatus 10 determines whether or not there is a person (ID) satisfying the above-mentioned conditions for the setting unit 16. The surveillance control apparatus 10 may add the same conditions as those in the first example embodiment (conditions in which the total detected number of times is greater than a predetermined number of times) to the above-mentioned conditions.

### [Advantages and Effects of Second Example Embodiment]

In the second example embodiment, the identification information of the type of the detected predetermined motion is set in the record added to the detection information storage unit 15 in response to the detection of the predetermined motion. Then, the detected number of times for each type of the predetermined motions of the person indicated by the information stored in the detection information storage unit 15 is counted, and a suspect is determined on the basis of the detected number of times for each motion type. In the determination of the suspect, the result of comparison between the detected number of times for each motion type and the predetermined number of times for each motion type may be used, and the score obtained by weighting the detected number of times for each type of the predetermined motions in accordance with each type of the predetermined motions may be used.

As described above, according to the second example embodiment, the type of the detected predetermined motion is managed, and a suspect is determined on the basis of the detected number of times for each type of the predetermined motions. That is, according to the second example embodiment, it is possible to distinguish between a predetermined motion having a high likelihood of being performed by a suspect and a predetermined motion having a low likelihood thereof. For example, the second motion of looking up toward the ceiling (the motion of checking the presence of surveillance cameras) has a higher possibility of a suspect shoplifter than the first motion of looking a product held in the person's hand. That is, a person who performs the second motion 5 times is more likely to be a shoplifter than a person who performs the first motion 10 times. According to the second example embodiment, a suspect is determined while distinguishing between the detected number of times of a predetermined motion having a high likelihood of being performed by a suspect and the detected number of times of a predetermined motion having a low likelihood thereof. As a result, it is possible to further improve the determination accuracy of the suspect.

### [Supplement to First Example Embodiment and Second Example Embodiment]

Although not mentioned in particular in the description of each example embodiment, the period of detection of the predetermined motion, set to be counted in the number of times, may be limited. For example, in a case where the surveillance control apparatus 10 (the sensing unit 13) continuously detects a predetermined motion for a long period such as one year, the period of the detection information stored in the detection information storage unit 15 also becomes long. In a case where all predetermined motions detected for such a long period are set as motions used for setting a suspect, the possibility of erroneous determination of the suspect increases. Therefore, the surveillance control apparatus 10 preferably excludes records, from records to be counted in the number of times, each indicating a person who is not set as a suspect and a time before the predetermined period of time on the basis of the time set in the time field.

The surveillance control apparatus 10 may exclude a record indicating a time before the predetermined period from the records to be counted in the number of times, in the following manner. For example, the surveillance control apparatus 10 (storage processing unit 14) acquires the latest time from the record stored in the detection information storage unit 15, and deletes a record, from the detection information storage unit 15, indicating a time before the predetermined period of time from the latest time other than the record in which the suspect flag (1) is set. Further, the surveillance control apparatus 10 (storage processing unit 14) sets an exclusion flag in a record indicating the time before the predetermined period from the latest time other than the record in which the suspect flag (1) is set. Furthermore, the surveillance control apparatus 10 (setting unit 16) counts the detected number of times of records not set with the suspect flag (1) and included within a predetermined period from the latest time.

The shorter the period set for the predetermined period, the higher the accuracy of determination of the suspect. The reason for this is that the repeated suspicious motion (predetermined motion) in a shorter period means a higher possibility of the motion being performed by a suspect.

### Third Example Embodiment

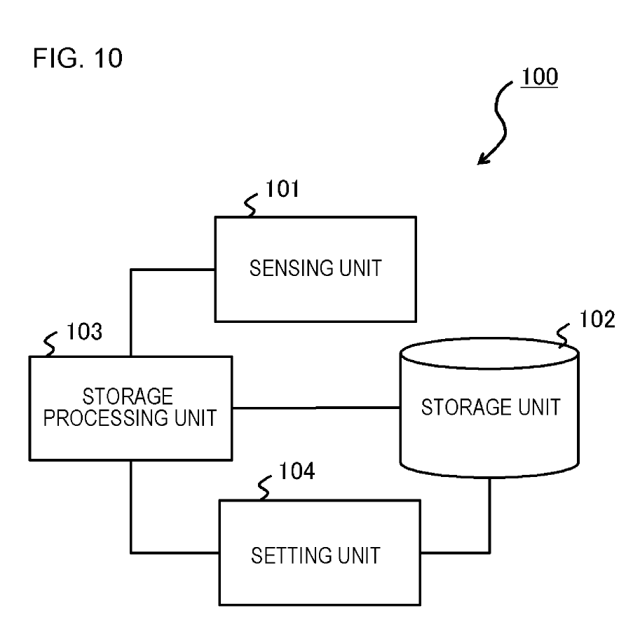

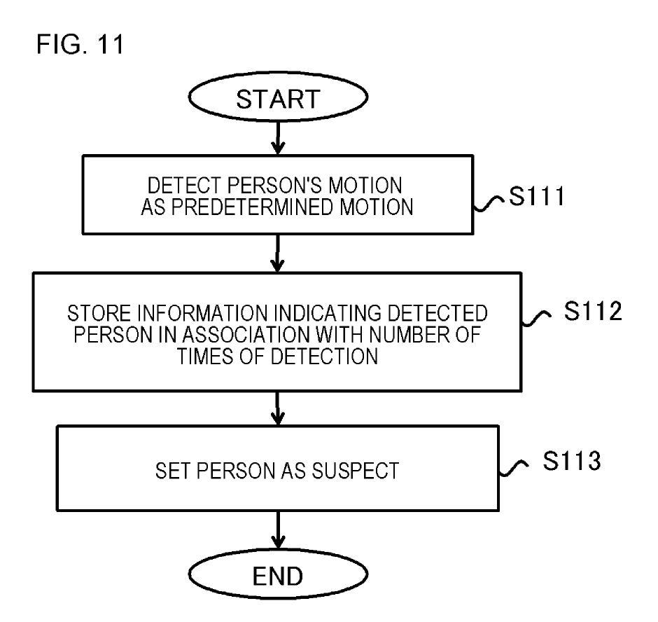

Hereinafter, a surveillance system and a surveillance method according to a third example embodiment will be described with reference to FIGS. 10 and 11. Further, the third example embodiment may be a program which causes at least one computer to execute the surveillance method, and may be a storage medium in which such a program is recorded and which can be read by at least one computer.

FIG. 10 is a diagram conceptually illustrating a processing configuration example of the surveillance system 100 according to the third example embodiment. As shown in FIG. 10, the surveillance system 100 includes a sensing unit 101, a storage processing unit 103, and a setting unit 104. The surveillance system 100 is implemented by one computer or a plurality of computers. The computer, which implements the surveillance system 100, has, for example, the same hardware configuration as the above-mentioned surveillance control apparatus 10 shown in FIG. 1. The storage unit 102 may be provided by the surveillance system 100, and may be provided by another computer.

The sensing unit 101, the storage processing unit 103, and the setting unit 104 are implemented by causing the CPU 2 to execute a program stored in the memory 3. Further, the program may be installed from a portable storage medium such as a CD or a memory card or another computer on the network through the communication unit 5, and may be stored in the memory 3. The surveillance camera 9, the display apparatus 7, and the input apparatus 8 do not have to be connected to the surveillance control apparatus 10. The surveillance system 100 is able to acquire image data from another computer, a portable storage medium, or the like. Further, the surveillance system 100 may output some display on the display unit of another computer.

The sensing unit 101 detects a predetermined motion of a person appearing in a video. The video is a moving image or a still image. Further, the video may be a real-time video, and may be a recorded video. The predetermined motion means a motion of a person which can be determined in advance, and the specific contents thereof are as described above. The predetermined motion may be a certain predetermined motion, and may be multiple types of predetermined motions as in the above-mentioned example embodiment. The specific processing contents of the sensing unit 101 are the same as those of the sensing unit 13 described above.

The storage processing unit 103 stores the information indicating the person whose motion is detected as the above-mentioned predetermined motion, in association with the detected number of times, in the storage unit 102. The information, which is stored in the storage unit 102 and indicates the person, is, for example, the image or ID of the person in the above-mentioned example embodiment. The specific contents of the information are not limited. Further, a format of storage in the storage unit 102 is not limited. The detected number of times may be stored together with the information indicating the person, and the detected number of times may be indicated by the number of records as in the above-mentioned example embodiment.

The setting unit 104 sets the person as a suspect, on the basis of the detected number of times that can be acquired from the storage unit 102. The suspect is a person to be determined, and is not limited to a specific person. The suspect includes persons who are difficult to be uniformly determined as suspects on the basis of certain motions, who continuously exhibit specific behaviors. As exemplified in the above-mentioned example embodiment, for example, the suspect includes a suspect thief such as a shoplifter or a pickpocket, a suspect molester, a prowler who is likely to be a criminal, a child who is likely lost, or the like.

The setting performed by the setting unit 104 can be implemented by storing information indicating that the person is a suspect, in the storage unit 102, together with information indicating that person. In addition, the setting may be implemented by presenting the person as a suspect. Specific processing contents of the setting unit 104 are the same as those of the setting unit 16 described above.

FIG. 11 is a flowchart illustrating an operation example of the surveillance system 1 according to the third example embodiment. As shown in FIG. 11, the surveillance method according to the third example embodiment is executed by at least one computer included in the surveillance system 1. For example, each step shown in the drawing is executed by each of the above-mentioned processing modules of the surveillance system 1. Since each step is the same as the above-mentioned processing contents of each processing module described above, details of each step will not be repeated.

The surveillance method according to the present example embodiment includes (S111), (S112) and (S113). In (S111), the surveillance system 100 detects a predetermined motion of a person appearing in a video. In (S112), the surveillance system 100 stores information indicating the person whose motion is detected as a predetermined motion in the storage unit 102, in association with the detected number of times. In (S113), the surveillance system 100 sets the person as a suspect, on the basis of the detected number of times.

In the third example embodiment, the predetermined motion of the person appearing in the video is detected, and information indicating the person whose motion is detected as a predetermined motion, is stored in the storage unit 102 in association with the detected number of times. In the third example embodiment, the person is set as a suspect, on the basis of the detected number of times obtained from the storage unit 102. As described above, according to the third example embodiment, it is possible to prevent immediate determination of persons performing predetermined motions as suspects by merely detecting the predetermined motions, and it is possible to determine suspects in consideration of the detected number of times. Thereby, even in a case where an ordinary person who is not a suspect accidentally performs a predetermined motion, the ordinary person is hardly determined as a suspect. According to the third example embodiment, it is possible to reduce erroneous determination of the suspect by considering the detected number of times. As a result, it is possible to improve the accuracy of determination of the suspect.

In the plurality of flowcharts used in the above description, plural steps (processes) are sequentially described, but the order of the steps executed in each example embodiment is not limited to the order of description. In each example embodiment, it is possible to change the order of steps shown in the drawing within a range that does not cause a problem in terms of the contents thereof. Further, the above-mentioned example embodiments may be combined within a range in which the contents do not contradict each other.

The above-mentioned contents may be determined as follows. However, the above-mentioned contents are not limited to the following description.

1. A surveillance system including:

a sensing unit that detects a predetermined motion of a person appearing in a video;

a storage processing unit that causes a storage unit to store information indicating the person whose motion is detected as a predetermined motion, in association with the detected number of times; and

a setting unit that sets the person as a suspect on the basis of the detected number of times.

2. The surveillance system according to 1,

in which the storage processing unit causes the storage unit to store information of a time of occurrence of the detected predetermined motion, in addition to the information indicating the person whose motion is detected as a predetermined motion, and

in which the setting unit sets the person as a suspect on the basis of the detected number of times acquired from the storage unit during a predetermined time period.

3. The surveillance system according to 1 or 2,

in which the storage processing unit causes the storage unit to store image information of a person whose motion is detected as a predetermined motion, and

in which the setting unit counts the detected number of times for each person on the basis of the image information stored in the storage unit.

4. The surveillance system according to any one of 1 to 3,

in which the storage processing unit causes the storage unit to store information of a location and a time of occurrence of the detected predetermined motion, in addition to the information indicating the person whose motion is detected as a predetermined motion, and

in which the setting unit counts the detected number of times for each person, on the basis of the information of the person, the location, and the time stored in the storage unit.

5. The surveillance system according to any one of 1 to 4,

in which the sensing unit detects each of a plurality of types of predetermined motions of a person appearing in a video, and

in which the storage processing unit causes the storage unit to store information, indicating a person whose motions are detected as a plurality of types of predetermined motions, in association with the detected number of times.

6. The surveillance system according to 5,

in which the storage processing unit causes the storage unit to store information, indicating types of the detected predetermined motions, in addition to the information indicating the person whose motions are detected as a plurality of types of predetermined motions, and

in which the setting unit counts the detected number of times of each type of the predetermined motions of the person, and sets the person as a suspect, on the basis of the detected number of times of each type of the predetermined motions.

7. The surveillance system according to 6,

in which the setting unit sets the person as a suspect, on the basis of a score obtained by weighting the detected number of times of each type of the predetermined motions of the person in accordance with each type of the predetermined motions.

8. The surveillance system according to any one of 1 to 7, further including

a display processing unit that causes a display unit to display a video including the person set as the suspect added with information allowing to identify the person set as the suspect in the video.

9. The surveillance system according to any one of 1 to 8,

in which the storage processing unit causes the storage unit to store information indicating that the person is set as the suspect in association with the information indicating the person whose motion is detected as the predetermined motion, and

in which the surveillance system further includes:

a detection unit that detects a person presumed to be the suspect, from the video, on the basis of the information stored in the storage unit in association with the information indicating that the person is set as the suspect; and

a notification unit that notifies that the detection unit has detected the person presumed to be the suspect.

10. The surveillance system according to 9,

in which, in a case where the detection unit has detected a person presumed to be the suspect, the notification unit causes the display unit to display a video added with information allowing to identify the detected person.

11. The surveillance system according to any one of 1 to 10,

in which the storage processing unit causes the storage unit to store an image of the person whose motion is detected as a predetermined motion and the information indicating that the person is set as the suspect in association with each other, and

in which the surveillance system further includes

a display processing unit that causes the display unit to display a list of suspects including an image of each suspect on the basis of the information stored in the storage unit in association with the information indicating that the person is set as the suspect.

12. A surveillance method executed by at least one computer, the surveillance method including:

detecting a predetermined motion of a person appearing in a video;

storing in a storage unit information indicating the person whose motion is detected as a predetermined motion, in association with the detected number of times; and

setting the person as a suspect on the basis of the detected number of times.

13. The surveillance method according to 12, further including

storing in the storage unit information of a time of occurrence of the detected predetermined motion, in addition to the information indicating the person whose motion is detected as a predetermined motion,

in which, in the step of setting the person as a suspect, the person is set as a suspect on the basis of the detected number of times which is acquired from the storage unit during a predetermined time period.

14. The surveillance method according to 12 or 13, further including:

storing in the storage unit image information of a person whose motion is detected as a predetermined motion; and

counting the detected number of times for each person on the basis of the image information stored in the storage unit.

15. The surveillance method according to any one of 12 to 14, further including:

storing in the storage unit information of a location and a time of occurrence of the detected predetermined motion, in addition to the information indicating the person whose motion is detected as a predetermined motion; and

counting the detected number of times for each person, on the basis of the information of the person, the location, and the time stored in the storage unit.

16. The surveillance method according to any one of 12 to 15,

in which, the step of detecting is detecting each of a plurality of types of predetermined motions of a person appearing in a video, and

in which, the step of storing is storing in the storage unit information indicating a person whose motions are detected as a plurality of types of predetermined motions, in association with the detected number of times.

17. The surveillance method according to 16, further including:

storing in the storage unit information indicating types of the detected predetermined motions, in addition to the information indicating the person whose motions are detected as a plurality of types of predetermined motions; and

counting the detected number of times of each type of the predetermined motions of the person,

in which, in the step of setting the person as a suspect, the person is set as a suspect on the basis of the detected number of times of each type of the predetermined motions.

18. The surveillance method according to 17,

in which the step of setting the person as a suspect is setting the person as a suspect on the basis of a score obtained by weighting the detected number of times of each type of the predetermined motions of the person in accordance with each type of the predetermined motions.

19. The surveillance method according to any one of 12 to 18, further including

displaying on a display unit a video including the person set as the suspect added with information allowing to identify the person set as the suspect within the video.

20. The surveillance method according to any one of 12 to 19, further including:

storing in the storage unit information indicating that the person is set as the suspect in association with the information indicating the person whose motion is detected as a predetermined motion;

detecting a person presumed to be the suspect from the video on the basis of the information stored in the storage unit in association with the information indicating that the person is set as the suspect; and

notifying the detection of the person presumed to be the suspect.

21. The surveillance method according to 20, further including

displaying on the display unit a video acquired by adding information allowing to identify the detected person to the video, in a case where a person presumed to be the suspect is detected.

22. The surveillance method according to any one of 12 to 21, further including:

storing in the storage unit an image of the person whose motion is detected as a predetermined motion and the information indicating that the person is set as the suspect in association with each other; and

displaying on the display unit a list of suspects including an image of each suspect on the basis of the information stored in the storage unit in association with the information indicating that the person is set as the suspect.

23. A program for causing at least one computer to execute the surveillance method according to any one of Nos. 12 to 22.

This application claims the benefits of priority based on Japanese Unexamined Patent Application Publication No. 2015-056875 filed on Mar. 19, 2015, and the entire contents of the application are incorporated herein by reference.

1. A surveillance system comprising:
a memory configured to store instructions; and
a processor configured to execute the instructions to:
detect a predetermined motion of a person appearing in a video;
store information indicating the person whose motion is detected as a predetermined motion, in association with time information indicating time in which the detected predetermined motion is performed; and
set the person as a suspect on the basis of the detected number of times of the predetermined motion during a predetermined time period for the person, the detected number of times.

2. The surveillance system according to claim 1,
wherein the storage processing unit processor is further configured to execute the instructions to:
causes the storage unit to store identification information of a time of occurrence of the detected predetermined motion, in addition to the information indicating the person whose motion is detected as a predetermined motion, and for identifying each person;
wherein the setting unit sets the person as a suspect on the basis of the detected number of times acquired from the storage unit during a predetermined time period determine whether a plurality of pieces of different identification information are associated with the same person based on the information for each person; and
update, when the plurality of different pieces of identification information are associated with the same person, the plurality of different pieces of identification information with the same identification information.

3. The surveillance system according to claim 1,
wherein the storage processing unit processor is further configured to execute the instructions to:
causes the storage unit to store image information of a person whose motion is detected as a predetermined motion; and
wherein the setting unit counts count the detected number of times for each person on the basis of the image information stored in the storage unit.

4. The surveillance system according to claim 1,
wherein the storage processing unit processor is further configured to execute the instructions to:
causes the storage unit to store information of a location and a time of occurrence of the detected predetermined motion, in addition to the information indicating the person whose motion is detected as a predetermined motion; and
wherein the setting unit counts count the detected number of times for each person, on the basis of the information of the person, the location, and the time stored in the storage unit.

5. The surveillance system according to claim 1,
wherein the sensing unit processor is further configured to execute the instructions to:
detects detect each of a plurality of types of predetermined motions of a person appearing in a video; and
store information indicating a person whose motions are detected as the plurality of types of predetermined motions, in association with the detected number of times.

6. The surveillance system according to claim 5,
wherein the storage processing unit processor is further configured to execute the instructions to:
store information indicating types of the detected predetermined motions, in addition to the information indicating the person whose motions are detected as the plurality of types of predetermined motions; and
counts count the detected number of times of each type of the predetermined motions of the person, and sets the person as a suspect, on the basis of the detected number of times of each type of the predetermined motions.

7. The surveillance system according to claim 6,
wherein the processor is further configured to execute the instructions to set the person as a suspect, on the basis of a score obtained by weighting the detected number of times of each type of the predetermined motions of the person in accordance with each type of the predetermined motions.

8. The surveillance system according to claim 1,
wherein the processor is further configured to execute the instructions to cause a display unit to display a video including the person set as the suspect, added with information allowing to identify the person set as the suspect within the video.

9. The surveillance system according to claim 1,
wherein the processor is further configured to execute the instructions to:
store information indicating that the person is set as the suspect in association with the information indicating the person whose motion is detected as a predetermined motion, and;
detect a person presumed to be the suspect from the video on the basis of the information in association with the information indicating that the person is set as the suspect; and
notify that the person presumed to be the suspect is detected.

10. The surveillance system according to claim 9,
wherein, in a case where a person presumed to be the suspect is detected, the processor is further configured to execute the instructions to cause the display unit to display a video added with information allowing to identify the detected person.

11. The surveillance system according to claim 1,
wherein the processor is further configured to:
causes the storage unit to store an image of the person whose motion is detected as a predetermined motion and the information indicating that the person is set as the suspect in association with each other; and
cause the display unit to display a list of suspects including an image of each suspect on the basis of the information in association with the information indicating that the person is set as the suspect.

12. A surveillance method executed by at least one computer, the surveillance method comprising:
detecting a predetermined motion of a person appearing in a video;
storing unit information indicating the person whose motion is detected as a predetermined motion, in association with time information indicating time in which the detected predetermined motion is performed; and
setting the person as a suspect on the basis of the detected number of times of the predetermined motion during a predetermined time period for the person, the detected number of times.

13. A non-transitory computer readable medium storing a program for causing at least one computer to execute a surveillance method, the surveillance method comprising:
detecting a predetermined motion of a person appearing in a video;
storing information indicating the person whose motion is detected as a predetermined motion, in association with time information indicating time in which the detected predetermined motion is performed; and
setting the person as a suspect on the basis of the detected number of times of the predetermined motion during a predetermined time period for the person, the detected number of times.

14. The surveillance system according to claim 2,
wherein processor is further configured to execute the instructions to:
store image information of a person whose motion is detected as a predetermined motion; and
count the detected number of times for each person on the basis of the image information.

15. The surveillance system according to claim 2,
wherein the processor is further configured to execute the instructions to:
store information of a location and a time of occurrence of the detected predetermined motion, in addition to the information indicating the person whose motion is detected as a predetermined motion; and
count the detected number of times for each person, on the basis of the information of the person, the location, and the time.

16. The surveillance system according to claim 3,
wherein the processor is further configured to execute the instructions to:
store information of a location and a time of occurrence of the detected predetermined motion, in addition to the information indicating the person whose motion is detected as a predetermined motion; and
count the detected number of times for each person, on the basis of the information of the person, the location, and the time.

17. The surveillance system according to claim 14,
wherein the processor is further configured to execute the instructions to:
store information of a location and a time of occurrence of the detected predetermined motion, in addition to the information indicating the person whose motion is detected as a predetermined motion; and
count the detected number of times for each person, on the basis of the information of the person, the location, and the time.

18. The surveillance system according to claim 2,
wherein the processor is further configured to execute the instructions to:
detect each of a plurality of types of predetermined motions of a person appearing in a video; and
store information indicating a person whose motions are detected as the plurality of types of predetermined motions, in association with the detected number of times.

19. The surveillance system according to claim 3,
wherein the processor is further configured to execute the instructions to:
detect each of a plurality of types of predetermined motions of a person appearing in a video; and
store information indicating a person whose motions are detected as the plurality of types of predetermined motions, in association with the detected number of times.

20. The surveillance system according to claim 4,
wherein the processor is further configured to execute the instructions to:
detect each of a plurality of types of predetermined motions of a person appearing in a video; and
store information indicating a person whose motions are detected as the plurality of types of predetermined motions, in association with the detected number of times.
